(19) United States
(12) Patent Application Publication
(10) Pub. No.: US 2004/0205916 A1
(43) Pub. Date: Oct. 21, 2004

(54) Cosmetic brush handle

(76) Inventor: Young-Kwang Byun, Seoul (KR)

Correspondence Address: BIRCH STEWART KOLASCH & BIRCH, PO BOX 747, FALLS CHURCH, VA, 22040-0747, US

(21) Appl. No.: 10/671,441

(22) Filed: Sep. 29, 2003

(30) Foreign Application Priority Data
Apr. 15, 2003 (KR) 2003-0023581

(51) Int. Cl. B25G 1/00

(52) U.S. Cl. 15/143.1; 16/111.1

(57) ABSTRACT

A cosmetic handle including a substantially hollow transparent member, a substantially transparent receptacle member adapted to house a display pattern, said receptacle being structured to enable it to be inserted into the substantially hollow transparent member to enable the display pattern to be visible at, at least two sides of the handle.

This non-provisional application claims priority under 35 U.S.C. § 119(a) based on Patent Application No. 2003-0023581 filed in Korea on Apr. 15, 2003, the subject matter of which is herein incorporated by reference.

### BACKGROUND OF THE INVENTION

1. Field of the Invention

The present invention relates to a cosmetic brush provided with a handle which is transparent and which includes a transparent receptacle for housing various types of patterns which can be suspended in an oil.

2. Description of Related Art

Various types of cosmetic brush handles are known in the art. Generally, a conventional cosmetic brush handle is made of wood or plastic, has the configuration of a cylinder, or a multi-sided structure and is made of a transparent material having various types of pattern curved thereon.

However, such a conventional cosmetic brush handle suffers from a number of problems. For example, since such a conventional cosmetic brush handle is made of wood or plastic with little visual effect, the user becomes bored. Even when the cosmetic brush handle is provided with various types of patterns or curves thereon, since these patterns cannot be varied, the visual effect becomes state.

### SUMMARY OF THE INVENTION

Accordingly, it is an object of the present invention to provide a cosmetic brush handle which eliminates the above problems encountered with conventional cosmetic brush handle.

Another object of the present invention is to provide an improved cosmetic brush handle containing a transparent handle which includes a transparent receptacle adapted to contain a variety of different types of patterns which are interchangeable, as desired.

A further object of the present invention is to provide a cosmetic brush handle including a changeable receptacle adapted to a variety of pattern which can be disposed in an oil, thereby providing an oil interface between the patterns and the viewer.

Still another object of the present invention is to provide a cosmetic brush handle which is simple in structure, inexpensive to manufacture, durable in use, and refined in appearance.

Briefly described, the present invention is directed to a cosmetic brush handle containing a transparent and exchangeable receptacle disposed in a hollow member, wherein the transparent and exchangeable receptacle is adapted to receive a plurality of different patterns. Advantageously, the receptacle can be surrounded by oil disposed in the hollow brush handle creating a magnification of the patterns disposed in the receptacle. If the receptacle is not used, the patterns can be merely suspended and permitted to move freely within the oil, creating constant movement of the patterns therein.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a cosmetic brush handle attached to a stainless steel crip to form the cosmetic brush of the present invention;

FIG. 2 is an explored perspective view of FIG. 1;

FIG. 3 is a sectional view taken along line A-A in FIG. 1;

FIG. 4 is a sectional view, taken along line B-B in FIG. 3; and

FIG. 5 is an enlarged sectional view of section C as seen in FIG. 4.

### DETAILED DESCRIPTION OF THE PREFERRED EMBODIMENTS

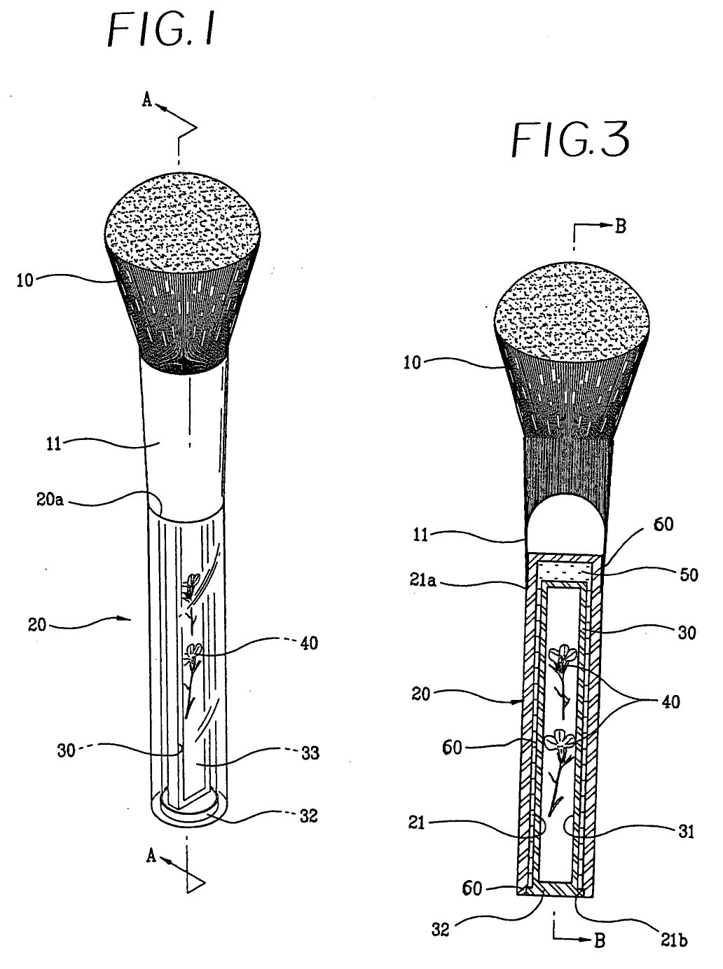

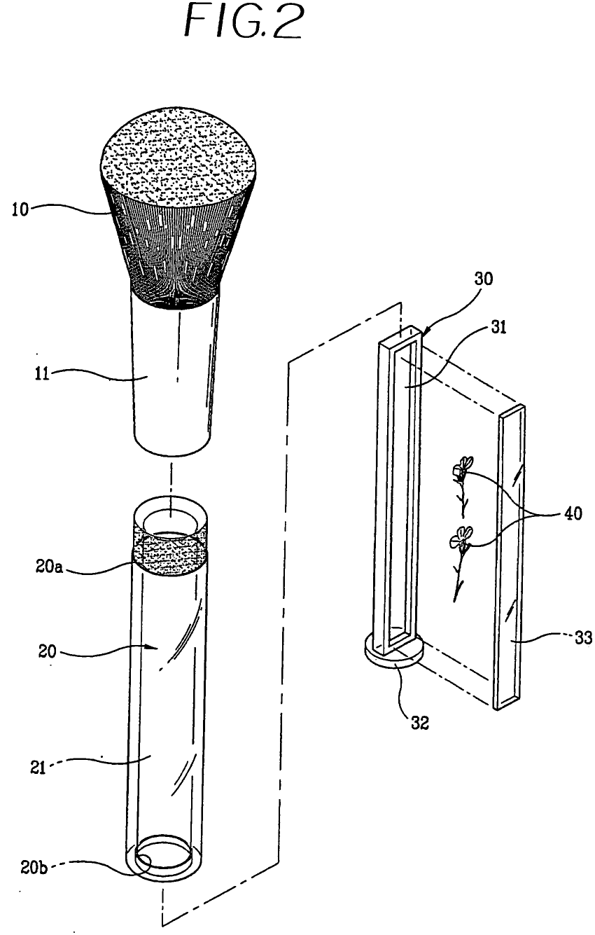

Referring now in detail to the drawings for the purpose of illustrating the present invention, the cosmetic brush handle as shown in FIGS. 1 and 2, includes a transparent tubular hollow handle 20 which defines a hollow chamber 21 for receiving a transparent receptacle 30 which is adapted to display a desired pattern.

The transparent tubular handle 20 has an engaging projection 20a disposed at the upper end portion thereof for mounting to a stainless steel crip 11 of a brush 10 and a sealing projection 20b disposed at the lower end portion thereof for mounting to a cap plate 32 provided at the end of the transparent receptacle 30.

Referring in detail to FIGS. 2 and 3, the transparent receptacle 30 includes a chamber 31 extending to the cap plate 32 disposed at a lower end portion thereof for receiving a variety of interchangeable patterns. 40. A transparent sealing attachment 33 is provided for sealing the chamber 31 with adhesives 60. The transparent receptacle 30 containing patterns 40 is inserted to the hollow chamber 21 of the transparent tubular handle 20. Advantageously, an oil is provided in the chamber 21, which surrounds the transparent receptacle providing a unique effect when viewing the patterns through the transparent handle. In another embodiment, the receptacle for housing the patterns could be eliminated, and the patterns could be allowed to float in the oil and thus move with the movement of the brush.

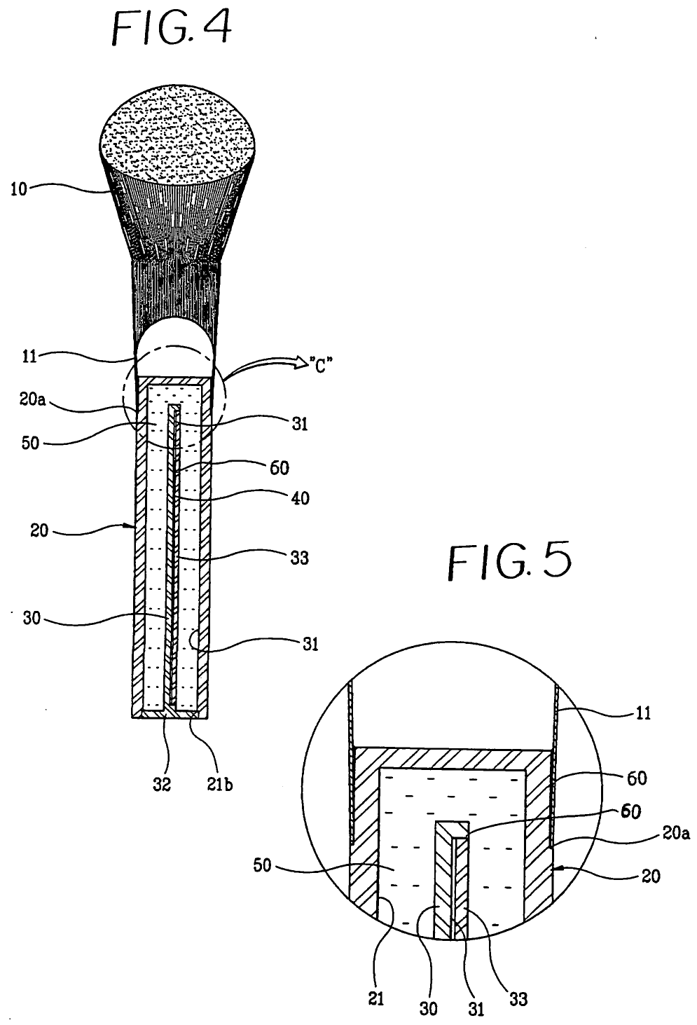

As shown in FIG. 5, the stainless crip 11 containing the brush is adhered with the engaging projection 20a extending from the transparent handle 20 at the upper portion thereof through the adhesives 60. Also, the cap plate 32 is adhered with the sealing projection 21b extending from the transparent tubular handle 20 at the lower portion thereof through the adhesives 60 as shown in FIGS. 3 and 4. The brush 10 is mounted to the stainless crip 11.

The brush 10 can be made of natural wool such as sheep's wool, weasel's wool, etc., for providing a soft application to a users face. The patterns 40 when viewed within the transparent oil 50 take on an enlarged appearance for the user to observe. Therefore, the user can visually enjoy the makeup face brush while applying makeup to the face.

Although the brush handle is normally cylindrical in shape, alternatively, it can have any desired shape, e.g., square, hexagonal, etc., for adding overall artistic value to the brush.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cosmetic handle comprising:
a substantially hollow transparent member; and
a substantially transparent receptacle member adapted to house a display pattern, said receptacle being structured to enable it to be inserted into the substantially hollow transparent member to enable the display pattern to be visible at, at least two sides of the handle.

2. The cosmetic handle of claim 1, wherein the substantially hollow transparent member contains an oil, whereby the display pattern is visible through an oil interface.

3. The cosmetic handle of claim 1, wherein the substantially hollow transparent handle is provided at one end thereof with a brush.

4. The cosmetic handle of claim 1, wherein the transparent receptacle is sealed within the hollow transparent member by adhesives. o the cap plate of the transparent receiver through adhesives.
